(19) United States
(12) Patent Application Publication
(10) Pub. No.: US 2024/0283057 A1
(43) Pub. Date: Aug. 22, 2024

(54) GEL-BASED SOLID-STATE BATTERY CELL

(71) Applicant: GM GLOBAL TECHNOLOGY OPERATIONS LLC, DETROIT, MI (US)

(72) Inventors: Yong LU, Shanghai (CN); Zhe Li, Shanghai (CN); Qili SU, Shanghai (CN); Dave G. RICH, Sterling Heights, MI (US); Haijing LIU, Shanghai (CN)

(21) Appl. No.: 18/360,086

(22) Filed: Jul. 27, 2023

(30) Foreign Application Priority Data
Feb. 16, 2023 (CN) 202310168844.6

(51) Int. Cl. H01M 12/02

(52) U.S. Cl. CPC H01M 12/02; H01M 2300/0085

(57) ABSTRACT

A solid-state battery cell includes an anode electrode comprising an anode current collector and an anode coating. A cathode electrode comprises a cathode current collector and a cathode coating, wherein the anode electrode and the cathode electrode exchange lithium ions. A separator layer is arranged between the anode electrode and the cathode electrode. A first capacitor electrode is arranged at least one of between the anode coating and a first side of the separator layer, between the anode coating and the anode current collector, between a second side of the separator layer and the cathode coating, and between the cathode coating and the cathode current collector.

### CROSS-REFERENCE TO RELATED APPLICATIONS

This application claims the benefit of Chinese Patent Application No. 202310168844.6, filed on Feb. 16, 2023. The entire disclosure of the application referenced above is incorporated herein by reference.

### INTRODUCTION

The information provided in this section is for the purpose of generally presenting the context of the disclosure. Work of the presently named inventors, to the extent it is described in this section, as well as aspects of the description that may not otherwise qualify as prior art at the time of filing, are neither expressly nor impliedly admitted as prior art against the present disclosure.

The present disclosure relates to battery cells, and more particularly to gel-based solid-state battery cells.

Electric vehicles (EVs) such as battery electric vehicles (BEVs), hybrid vehicles, and/or fuel cell vehicles include one or more electric machines and a battery system including one or more battery cells, modules and/or packs. A power control system is used to control charging and/or discharging of the battery system during charging and/or driving. Manufacturers of EVs are pursuing increased power density to increase the range of the EVs.

Solid-state batteries (SSBs) with solid electrolyte have the potential to be superior to the state-of-the-art lithium-ion batteries (LIBs) in terms of abuse tolerance, working temperature range and system design.

### SUMMARY

A solid-state battery cell includes an anode electrode comprising an anode current collector and an anode coating. A cathode electrode comprises a cathode current collector and a cathode coating, wherein the anode electrode and the cathode electrode exchange lithium ions. A separator layer is arranged between the anode electrode and the cathode electrode. A first capacitor electrode is arranged at least one of between the anode coating and a first side of the separator layer, between the anode coating and the anode current collector, between a second side of the separator layer and the cathode coating, and between the cathode coating and the cathode current collector.

In other features, the first capacitor electrode is arranged between the anode coating and the first side of the separator layer. A second capacitor electrode is arranged between the second side of the separator layer and the cathode coating. The first capacitor electrode is arranged between the anode coating and the anode current collector and further comprising a second capacitor electrode arranged between the cathode coating and the cathode current collector. The first capacitor electrode is arranged between the anode coating and the first side of the separator layer and further comprising a second capacitor electrode arranged between the cathode coating and the cathode current collector.

In other features, the first capacitor electrode is arranged between the anode coating and the anode current collector and further comprising a second capacitor electrode arranged between the cathode coating and the second side of the separator layer. The anode coating comprises an anode active material including one or more materials selected from a group consisting of silicon-based material, carbonaceous material, metal, metal alloy, and metal oxide. The cathode coating comprises a cathode active material selected from a group consisting of an olivine material, a rock salt layered oxide, a spinel material, a polyanion material, other lithium transition-metal oxides, and a surface coated or doped cathode material.

In other features, the separator layer is selected from a group consisting of a polymer-based separator embedded with gel electrolyte, a free-standing gel membrane, a solid electrolyte layer with gel electrolyte, and a solid electrolyte layer. The separator layer comprises a polymer layer. The separator layer comprises a polymer layer and a ceramic coating.

In other features, the separator layer comprises a free-standing gel membrane including a polymer and a liquid electrolyte. The free-standing gel membrane has a thickness in a range from 10 μm to 100 μm. The free-standing gel membrane comprises 10 wt % to 30 wt % polymer and 90 wt % to 70 wt % liquid electrolyte.

A solid-state battery cell comprises an anode electrode comprising an anode current collector, a first anode coating and a second anode coating. A first capacitor electrode is arranged between the first anode coating and the second anode coating. A cathode electrode comprises a cathode current collector and a first cathode coating, wherein the anode electrode and the cathode electrode exchange lithium ions. A separator layer is arranged between the second anode coating of the anode electrode and the cathode electrode.

In other features, the cathode electrode further comprises a second cathode coating and further comprising a second capacitor electrode arranged between the first cathode coating and the second cathode coating. The first anode coating comprises an anode active material including one or more materials selected from a group consisting of silicon-based material, carbonaceous material, metal, metal alloy, and metal oxide. The first cathode coating comprises a cathode active material including one or more materials selected from a group consisting of an olivine material, a rock salt layered oxide, a spinel material, a polyanion material, other lithium transition-metal oxides, and a surface coated or doped cathode material. The separator layer is selected from a group consisting of a polymer-based separator embedded with gel electrolyte, a free-standing gel membrane, a solid electrolyte layer with gel electrolyte, and a solid electrolyte.

In other features, the separator layer comprises a polymer layer. The separator layer comprises a polymer layer and a ceramic coating. The separator layer comprises a free-standing gel membrane including a polymer and a liquid electrolyte. The free-standing gel membrane has a thickness in a range from 10 μm to 100 μm. The free-standing gel membrane comprises 10 wt % to 30 wt % polymer and 90 wt% to 70 wt % liquid electrolyte.

A solid-state battery cell comprises an anode electrode comprising an anode current collector and an anode coating. A cathode electrode comprises a cathode current collector, a first cathode coating, and a second cathode coating. The anode electrode and the cathode electrode exchange lithium ions. A first capacitor electrode is arranged between the first cathode coating and the second cathode coating. A separator layer is arranged between the anode electrode and the cathode electrode.

In other features, the anode coating comprises an anode active material including one or more materials selected from a group consisting of silicon-based material, carbonaceous material, metal, metal alloy, and metal oxide. The first cathode coating comprises a cathode active material selected from a group consisting of an olivine material, a rock salt layered oxide, a spinel material, a polyanion material, other lithium transition-metal oxides, and a surface coated or doped cathode material. The separator layer is selected from a group consisting of a polymer-based separator embedded with gel electrolyte, a free-standing gel membrane, a solid electrolyte layer with gel electrolyte, and a solid electrolyte.

In other features, the separator layer comprises one of a polymer layer and a polymer layer and a ceramic coating.

In other features, the separator layer comprises a free-standing gel membrane including a polymer and a liquid electrolyte, the free-standing gel membrane has a thickness in a range from 10 μm to 100 μm, and the free-standing gel membrane comprises 10 wt % to 30 wt % polymer and 90wt % to 70 wt % liquid electrolyte.

Further areas of applicability of the present disclosure will become apparent from the detailed description, the claims, and the drawings. The detailed description and specific examples are intended for purposes of illustration only and are not intended to limit the scope of the disclosure.

### BRIEF DESCRIPTION OF THE DRAWINGS

The present disclosure will become more fully understood from the detailed description and the accompanying drawings, wherein:

FIGS. 1A to 1D are side cross-sectional views of solid-state battery cells including anode electrodes or cathode electrodes with capacitor layers according to the present disclosure;

FIGS. 2A to 2D are side cross-sectional views of solid-state battery cells including anode electrodes and cathode electrodes with capacitor layers according to the present disclosure; and

FIGS. 3A to 3C are side cross-sectional views of solid-state battery cells including anode sandwich electrodes and/or cathode sandwich electrodes with capacitor layers according to the present disclosure.

In the drawings, reference numbers may be reused to identify similar and/or identical elements.

### DETAILED DESCRIPTION

While the battery cells are described herein in the context of EVs, the battery cells can be used in stationary applications and/or in other applications.

Solid-state battery cells according to the present disclosure incorporate capacitor materials into multi-layer or sandwiched electrode structures to enhance the power of a gel-assisted solid-state battery. A capacitor-assisted solid-state battery (C-SSB) with the gel electrolyte has improved power response during fast charging and discharging events. Owing to the excellent power capability of capacitor materials, the discharge rate and fast-charging ability are enhanced.

A capacitor-assisted gel-based solid-state battery according to the present disclosure includes anode and/or cathode electrodes having a multi-layer or sandwiched structure enabled by CAB electrode (cabode) designs. The capacitor layers are arranged near the current collector, near the separating layer, and/or between two layers of the same electrode materials.

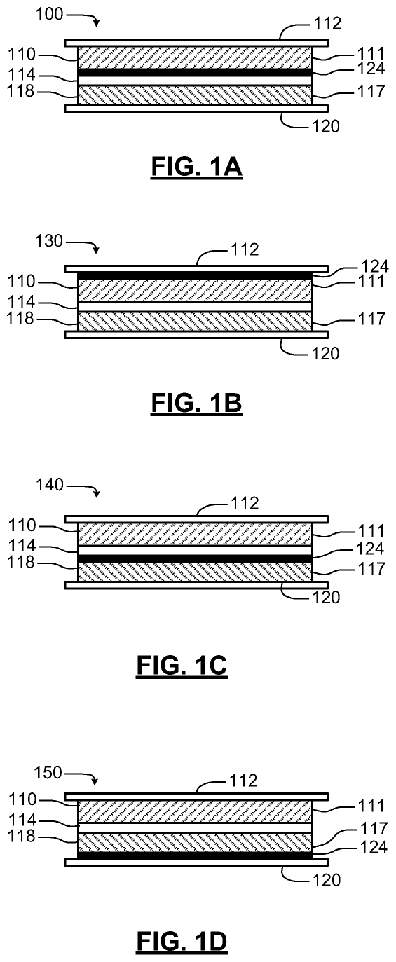

Referring now to FIGS. 1A to 1D, solid-state battery cells include anode electrodes or cathode electrodes with capacitor layers. In FIG. 1A, a battery cell 100 includes an anode electrode 110 including an anode coating 111 and an anode current collector 112, a separator 114, and a cathode electrode 117 including a cathode coating 118 and a cathode current collector 120. The anode coating 111 includes an anode active material, a solid electrolyte, a conductive additive, and/or a binder. The cathode coating 118 includes a cathode active material, a solid electrolyte, a conductive additive, and/or a binder. The battery cell 100 further includes a capacitor layer 124.

In FIG. 1A, the capacitor layer 124 is arranged between the anode coating 111 and the separator 114. In FIG. 1B, the capacitor layer 124 of a battery cell 130 is arranged between the anode coating 111 and the anode current collector 112. In FIG. 1C, the capacitor layer 124 of a battery cell 140 is arranged between the separator 114 and the cathode coating 118. In FIG. 1D, the capacitor layer 124 of a battery cell 150 is arranged between the cathode coating 118 and the cathode current collector 120.

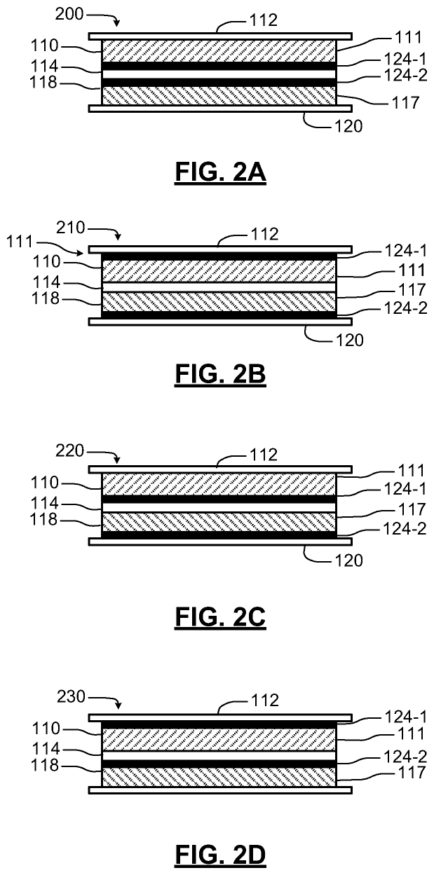

Referring now to FIGS. 2A to 2D, solid-state battery cells include anode electrodes and cathode electrodes with capacitor layers. In FIG. 2A, a capacitor layer 124-1 of a battery cell 200 is arranged between the anode coating 111 and the separator 114. A capacitor layer 124-2 is arranged between the separator 114 and the cathode coating 118.

In FIG. 2B, the capacitor layer 124-1 of a battery cell 210 is arranged between the anode coating 111 and the anode current collector 112. The capacitor layer 124-2 is arranged between the cathode coating 118 and the cathode current collector 120.

In FIG. 2C, the capacitor layer 124-1 of a battery cell 220 is arranged between the anode coating 111 and the separator 114. The capacitor layer 124-2 is arranged between the cathode coating 118 and the cathode current collector 120.

In FIG. 2D, the capacitor layer 124-1 of a battery cell 210 is arranged between the anode coating 111 and the anode current collector 112. The capacitor layer 124-2 is arranged between the separator 114 and the cathode coating 118.

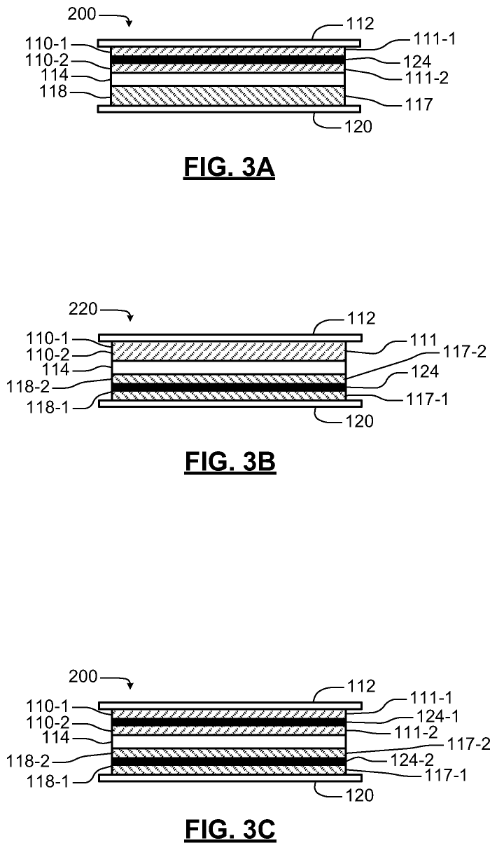

Referring now to FIGS. 3A to 3C, battery cells include anode sandwich electrodes and/or cathode sandwich electrodes with capacitor layers. In FIG. 3A, the anode electrode 110-1 and 110-2 includes a first anode coating 111-1 arranged adjacent to the anode current collector 112 and a second anode coating 111-2 arranged adjacent to the separator 114. The capacitor layer 124 is arranged between the first anode coating 111-1 and the second anode coating 111-2.

In FIG. 3B, the cathode electrode 118-1 and 118-2 includes a first cathode coating 118-1 arranged adjacent to the cathode current collector 120 and a second anode coating 118-2 arranged adjacent to the separator 114. The capacitor layer 124 is arranged between the first cathode coating 118-1 and the second anode coating 118-2.

In FIG. 3C, the anode electrode 110-1 and 110-2 includes the first anode coating 111-1 arranged adjacent to the anode current collector 112 and the second anode coating 111-2 arranged adjacent to the separator 114. The capacitor layer 124 is arranged between the first anode coating 111-1 and the second anode coating 111-2. The cathode electrode 117-1 and 117-2 includes the first cathode coating 118-1 arranged adjacent to the cathode current collector 120 and the second anode coating 118-2 arranged adjacent to the separator 114. The capacitor layer 124 is arranged between the first cathode coating 118-1 and the second anode coating 118-2.

In some examples, the capacitor layer 124 includes a capacitor active material, a conductive additive, a binder, and a solid electrolyte. In some examples, the capacitor active material is in a range from 50 wt % to 99 wt %, the conductive additive is in a range from 0 wt % to 30 wt %, the binder is in a range from 0 wt % to 20 wt %, and the solid electrolyte is in a range from 0 wt % to 30 wt %.

In some examples, the capacitor materials are selected from a group consisting of metal oxides, metal sulfides, carbon, and polymers. Examples of metal oxides comprise MOₓ where M=Co, Ru, Nb, etc. Examples of metal sulfides include TiS₂, CuS, FeS, etc. Examples of carbon include activated carbon, graphene, carbon nanotubes (CNT), etc. Examples of polymers include polyaniline, polyacetylene, etc.

In some examples, the binder of the capacitor layer is selected from a group consisting of poly(vinylidene fluoride) (PVDF), poly(vinylidene fluoride-co-hexafluoropropylene) (PVdF-HFP), poly(tetrafluoroethylene) (PTFE), sodium carboxymethyl cellulose (CMC), styrene-butadiene rubber (SBR), and nitrile butadiene rubber (NBR).

In some examples, the conductive additives in the capacitor layer are selected from a group consisting of carbon black, graphite, graphene, graphene oxide, Super P, acetylene black, carbon nanofibers, carbon nanotubes and other electronically conductive additives.

In some examples, the anode layer comprises an anode active material, a conductive additive, a binder, and a solid electrolyte. In some examples, the anode active material is in a range from 30 wt % to 95 wt %, the conductive additive is in a range from 0.1 wt % to 30 wt %, the binder is in a range from 1 wt % to 20 wt %, and the solid electrolyte is in a range from 1 wt % to 30 wt %.

In some examples, the anode active material includes one or more materials selected from a group consisting of silicon-based material, carbonaceous material, metal, metal alloy, and metal oxide. Examples of silicon-based materials include Si, SiOₓ, Si/C, SiOₓ/C, etc. Examples of carbonaceous material include graphite, hard carbon, soft carbon, etc. Examples of metal include Li, Sn, etc. Examples of metal oxide include SnO₂, Fe₃O₄, etc.

In some examples, the binder in the anode layer is selected from a group consisting of poly(vinylidene fluoride) (PVDF), poly(vinylidene fluoride-co-hexafluoropropylene) (PVdF-HFP), poly(tetrafluoroethylene) (PTFE), sodium carboxymethyl cellulose (CMC), styrene-butadiene rubber (SBR), nitrile butadiene rubber (NBR), and so on.

In some examples, the conductive additive in the anode layer is selected from a group consisting of carbon black, graphite, graphene, graphene oxide, Super P, acetylene black, carbon nanofibers, carbon nanotubes and other electronically conductive additives.

The SSB cathode layer is made of a cathode active material, a conductive additive, a binder, and a solid electrolyte. In some examples, the cathode active material is in a range from 30 wt % to 95 wt %, the conductive additive in a range from 0.1 wt % to 30 wt %, the binder in a range from 1 wt % to 20 wt %, and the solid electrolyte in a range from 1 wt % to 30 wt %.

In some examples, the cathode active material is selected from a group consisting of an olivine material, a rock salt layered oxide, a spinel material, a polyanion material, other lithium transition-metal oxides, and a surface coated or doped cathode material. Examples of the olivine material include LiFePO₄ and LiMnxFe₁₋ₓPO₄. Examples of rock salt layered oxides include LiCoO₂, LiNiₓMn_{y}Co_{1-x-y}O₂, LiNiₓMn_{y}Al_{1-x-y}O₂, LiNiₓMn₁₋ₓO₂, and Li₁₊ₓMO₂. Examples of the spinel material include LiMn₂O₄, LiNi_{0.5}Mn_{1.5}O₄, polyanion cathode (LiV₂(PO₄)₃), and other lithium transition-metal oxides. Examples of the surface-coated and/or doped cathode materials mentioned include LiNbO₃-coated LiNiMn_{y}Co_{1-x-y}O₂ and Al-doped LiNiₓMn_{y}Co_{1-x-y}O₂.

In some examples, the binder materials of the cathode layer are selected from a group consisting of poly(vinylidene fluoride) (PVDF), poly(vinylidene fluoride-co-hexafluoropropylene) (PVdF-HFP), poly(tetrafluoroethylene) (PTFE), sodium carboxymethyl cellulose (CMC), styrene-butadiene rubber (SBR), and nitrile butadiene rubber (NBR).

In some examples, the conductive additive of the cathode layer is selected from a group consisting of carbon black, graphite, graphene, graphene oxide, Super P, acetylene black, carbon nanofibers, carbon nanotubes and other electronically conductive additives.

In some examples, the separator is selected from a polymer-based separator embedded with gel electrolytes, a free-standing gel membrane or solid electrolyte layer with or without gel electrolytes.

In some examples, the separator comprises a polymer layer such as polypropylene (PP) and/or polyethylene (PE) with or without a coating layer. In some examples, the coating layer includes ceramic such as aluminum oxide (Al₂O₃), zirconium oxide (ZrO₂), or a solid electrolyte.

In other examples, the separator includes a high-temperature separator material such as polyimide (PI) nanofiber-based nonwoven material, a nano-sized Al₂O₃ and poly(lithium 4-styrenesulfonate)-coated polyethylene membrane, SiO₂ coated polyethylene (PE) separator, a co-polyimide-coated polyethylene separator, a polyetherimides (PEI) (bisphenol-aceton diphthalic anhydride (BPADA) and para-phenylenediamine) separator, an expanded polytetrafluoroethylene reinforced polyvinylidenefluoride-hexafluoropropylene separator, and a sandwich-structured PVdF/PMIA/PVdF nanofibrous separator.

In other examples, the separator comprises a free-standing gel membrane comprising a polymer and a liquid electrolyte. In some examples, the free-standing gel membrane has a thickness in a range from 10 μm to 100 μm. In some examples, the polymer comprises 10% to 30% polymer and 90% to 70% liquid electrolyte. In some examples, the polymer comprises one or more of polyacrylonitrile (PAN), polyethylene oxide (PEO), and/or polyacrylic acid (PAA).

In some examples, the solid electrolyte used in the capacitor layer, the anode layer, the separator, and the cathode layer include at least one electrolyte selected from a group consisting of an oxide-based solid electrolyte, a metal doped or aliovalent-substituted oxide solid electrolyte, a sulfide-based solid electrolyte, a nitride-based solid electrolyte, a hydride-based solid electrolyte, a halide-based solid electrolyte, and a borate-based solid electrolyte.

Examples of oxide-based solid electrolytes include garnet type (e.g., Li₇La₃Zr₂O₁₂), perovskite type (e.g., Li₃ₓLa_{2/3-x}TiO₃), NASICON type (e.g., Li_{1.4}Al_{0.4}Ti_{1.6}(PO₄)₃ and Li₁₊ₓ AlₓGe₂₋ₓ(PO₄)₃), and LISICON type (e.g., Li₂₊₂ₓZn₁₋ₓ GeO₄).

Examples of metal-doped or aliovalent-substituted oxide solid electrolyte include Al (or Nb)-doped Li₇La₃Zr₂O₁₂, Sb-doped Li₇La₂Zr₂O₁₂, Ga-substituted Li₇La₃Zr₂O₁₂, Cr and V-substituted LiSn₂P₃O₁₂, and Al-substituted perovskite, Li_{1+x+y}AlₓTi₂₋ₓSi_{y}P_{3-y}O₁₂.

Examples of sulfide-based solid electrolyte include Li₂S—P₂S₅ system, Li₂S—P₂S₅—MOₓ system, Li₂S—P₂S₅—MSₓ system, LGPS (Li₁₀GeP₂S₁₂), thio-LISICON (Li_{3.25}Ge_{0.25}P_{0.75}S₄), Li_{3.4}Si_{0.4}P_{0.6}S₄, Li₁₀GeP₂S_{11.7}O_{0.3}, lithium argyrodite Li₆PS₅X (X=Cl, Br, or I), Li_{9.54}Si_{1.74}P_{1.44}S_{11.7}Cl_{0.3}(25 mS/cm), Li_{9.6}P₃S₁₂, Li₇P₃S₁₁, Li₉P₃S₉O₃, Li_{10.35}Ge_{1.35}P_{1.65}S₁₂, Li_{10.35}Si_{1.35}P_{1.65}S₁₂, Li_{9.81}Sn_{0.81} P_{2.19}S₁₂, Li₁₀(Si_{0.5}Ge_{0.5}) P₂S₁₂, Li₁₀(Ge_{0.5}Sn_{0.5}) P₂S₁₂, Li₁₀(Si_{0.5}Sn_{0.5}) P₂S₁₂, Li_{3.833}Sn_{0.833}As_{0.166}S₄, LiI—Li₄SnS₄, and Li₄SnS₄.

Examples of nitride-based solid electrolyte include Li₃N, Li₇PN₄, and LiSi₂N₃. Examples of hydride-based solid electrolyte include LiBH₄, LiBH₄—LiX (X=Cl, Br, or I), LiNH₂, Li₂NH, LiBH₄—LiNH₂, and Li₃AlH₆. Examples of halide-based solid electrolyte include LiI, Li₃InCl₆, Li₂CdCl₄, Li₂MgCl₄, Li₂CdI₄, Li₂ZnI₄, Li₃OcI. Examples of borate-based solid electrolyte include Li₂B₄O₇ and Li₂O—B₂O₃—P₂O₅.

The capacitor assisted SSB may further comprising a gel electrolyte distributed inside the electrode layers and separating layers. In some examples, the gel electrolyte comprises a polymer host and a liquid electrolyte. In some examples, the polymer host is in a range from 0.1 wt % to 50 wt % and the liquid electrolyte is in a range from 50 wt % to 99.9 wt %. In some examples the polymer host is selected from a group consisting of polyvinylidene fluoride (PVDF), polyvinylidene fluoride-hexafluoropropylene(PVDF-HFP), polyethylene oxide(PEO), polypropylene oxide(PPO), polyacrylonitrile(PAN), polymethacrylonitrile (PMAN), and polymethyl methacrylate (PMMA).

In some examples, the liquid electrolyte includes carbonate solvents, a lithium salt, and/or an additive. In some examples, the carbonate solvent is selected from a group consisting of ethylene carbonate (EC), γ-butyrolactone (GBL), dimethyl carbonate (DMC), ethylmethyl carbonate (EMC), diethyl carbonate (DEC), and propylene carbonate (PC). In some examples, the lithium salt is selected from a group consisting of LiTFSI, LiBOB, LiDFOB, LIFSI, LiBETI, LiPF₆, LiBF₄, LiAsF₆, LiClO₄, and LiTfO. In some examples, the lithium salt comprises more than 0.8 M.

In some examples, the liquid electrolyte includes an additive selected from a group consisting of vinylene carbonate (VC), vinylethylene carbonate (VEC), butylene carbonate (BC), fluoroethylene carbonate (FEC), InCl₃, and ZnCl₂.

The foregoing description is merely illustrative in nature and is in no way intended to limit the disclosure, its application, or uses. The broad teachings of the disclosure can be implemented in a variety of forms. Therefore, while this disclosure includes particular examples, the true scope of the disclosure should not be so limited since other modifications will become apparent upon a study of the drawings, the specification, and the following claims. It should be understood that one or more steps within a method may be executed in different order (or concurrently) without altering the principles of the present disclosure. Further, although each of the embodiments is described above as having certain features, any one or more of those features described with respect to any embodiment of the disclosure can be implemented in and/or combined with features of any of the other embodiments, even if that combination is not explicitly described. In other words, the described embodiments are not mutually exclusive, and permutations of one or more embodiments with one another remain within the scope of this disclosure.

Spatial and functional relationships between elements (for example, between modules, circuit elements, semiconductor layers, etc.) are described using various terms, including “connected,” “engaged,” “coupled,” “adjacent,” “next to,” “on top of,” “above,” “below,” and “disposed.” Unless explicitly described as being “direct,” when a relationship between first and second elements is described in the above disclosure, that relationship can be a direct relationship where no other intervening elements are present between the first and second elements, but can also be an indirect relationship where one or more intervening elements are present (either spatially or functionally) between the first and second elements. As used herein, the phrase at least one of A, B, and C should be construed to mean a logical (A OR B OR C), using a non-exclusive logical OR, and should not be construed to mean “at least one of A, at least one of B, and at least one of C.”

In the figures, the direction of an arrow, as indicated by the arrowhead, generally demonstrates the flow of information (such as data or instructions) that is of interest to the illustration. For example, when element A and element B exchange a variety of information but information transmitted from element A to element B is relevant to the illustration, the arrow may point from element A to element B. This unidirectional arrow does not imply that no other information is transmitted from element B to element A. Further, for information sent from element A to element B, element B may send requests for, or receipt acknowledgements of, the information to element A.

What is claimed is:

1. A solid-state battery cell comprising:
an anode electrode comprising an anode current collector and an anode coating;
a cathode electrode comprising a cathode current collector and a cathode coating, wherein the anode electrode and the cathode electrode exchange lithium ions;
a separator layer arranged between the anode electrode and the cathode electrode; and
a first capacitor electrode arranged at least one of:
between the anode coating and a first side of the separator layer;
between the anode coating and the anode current collector;
between a second side of the separator layer and the cathode coating; and
between the cathode coating and the cathode current collector.

2. The solid-state battery cell of claim 1, wherein the first capacitor electrode is arranged between the anode coating and the first side of the separator layer and further comprising a second capacitor electrode arranged between the second side of the separator layer and the cathode coating.

3. The solid-state battery cell of claim 1, wherein the first capacitor electrode is arranged between the anode coating and the anode current collector and further comprising a second capacitor electrode arranged between the cathode coating and the cathode current collector.

4. The solid-state battery cell of claim 1, wherein the first capacitor electrode is arranged between the anode coating and the first side of the separator layer and further comprising a second capacitor electrode arranged between the cathode coating and the cathode current collector.

5. The solid-state battery cell of claim 1, wherein the first capacitor electrode is arranged between the anode coating and the anode current collector and further comprising a second capacitor electrode arranged between the cathode coating and the second side of the separator layer.

6. The solid-state battery cell of claim 1, wherein:
the anode coating comprises an anode active material including one or more materials selected from a group consisting of silicon-based material, carbonaceous material, metal, metal alloy, and metal oxide; and
the cathode coating comprises a cathode active material selected from a group consisting of an olivine material, a rock salt layered oxide, a spinel material, a polyanion material, other lithium transition-metal oxides, and a surface coated or doped cathode material.

7. The solid-state battery cell of claim 1, wherein the separator layer is selected from a group consisting of a polymer-based separator embedded with gel electrolyte, a free-standing gel membrane, a solid electrolyte layer with gel electrolyte, and a solid electrolyte layer.

8. The solid-state battery cell of claim 1, wherein the separator layer comprises a polymer layer.

9. The solid-state battery cell of claim 1, wherein the separator layer comprises a polymer layer and a ceramic coating.

10. The solid-state battery cell of claim 1, wherein:
the separator layer comprises a free-standing gel membrane including a polymer and a liquid electrolyte,
the free-standing gel membrane has a thickness in a range from 10 μm to 100 μm, and
the free-standing gel membrane comprises 10 wt % to 30 wt % polymer and 90 wt % to 70 wt % liquid electrolyte.

11. A solid-state battery cell comprising:
an anode electrode comprising an anode current collector, a first anode coating and a second anode coating;
a first capacitor electrode arranged between the first anode coating and the second anode coating;
a cathode electrode comprising a cathode current collector and a first cathode coating, wherein the anode electrode and the cathode electrode exchange lithium ions; and
a separator layer arranged between the second anode coating of the anode electrode and the cathode electrode.

12. The solid-state battery cell of claim 11, wherein the cathode electrode further comprises a second cathode coating and further comprising a second capacitor electrode arranged between the first cathode coating and the second cathode coating.

13. The solid-state battery cell of claim 11, wherein:
the first anode coating comprises an anode active material including one or more materials selected from a group consisting of silicon-based material, carbonaceous material, metal, metal alloy, and metal oxide,
the first cathode coating comprises a cathode active material including one or more materials selected from a group consisting of an olivine material, a rock salt layered oxide, a spinel material, a polyanion material, other lithium transition-metal oxides, and a surface coated or doped cathode material, and
the separator layer is selected from a group consisting of a polymer-based separator embedded with gel electrolyte, a free-standing gel membrane, a solid electrolyte layer with gel electrolyte, and a solid electrolyte.

14. The solid-state battery cell of claim 11, wherein the separator layer comprises a polymer layer.

15. The solid-state battery cell of claim 11, wherein the separator layer comprises a polymer layer and a ceramic coating.

16. The solid-state battery cell of claim 11, wherein:
the separator layer comprises a free-standing gel membrane including a polymer and a liquid electrolyte,
the free-standing gel membrane has a thickness in a range from 10 μm to 100 μm, and
the free-standing gel membrane comprises 10 wt % to 30 wt % polymer and 90 wt % to 70 wt % liquid electrolyte.

17. A solid-state battery cell comprising:
an anode electrode comprising an anode current collector and an anode coating;
a cathode electrode comprising a cathode current collector, a first cathode coating, and a second cathode coating,
wherein the anode electrode and the cathode electrode exchange lithium ions;
a first capacitor electrode arranged between the first cathode coating and the second cathode coating; and
a separator layer arranged between the anode electrode and the cathode electrode.

18. The solid-state battery cell of claim 17, wherein:
the anode coating comprises an anode active material including one or more materials selected from a group consisting of silicon-based material, carbonaceous material, metal, metal alloy, and metal oxide,
the first cathode coating comprises a cathode active material selected from a group consisting of an olivine material, a rock salt layered oxide, a spinel material, a polyanion material, other lithium transition-metal oxides, and a surface coated or doped cathode material, and
the separator layer is selected from a group consisting of a polymer-based separator embedded with gel electrolyte, a free-standing gel membrane, a solid electrolyte layer with gel electrolyte, and a solid electrolyte.

19. The solid-state battery cell of claim 17, wherein the separator layer comprises one of:
a polymer layer; and
a polymer layer and a ceramic coating.

20. The solid-state battery cell of claim 17, wherein:
the separator layer comprises a free-standing gel membrane including a polymer and a liquid electrolyte,
the free-standing gel membrane has a thickness in a range from 10 μm to 100 μm, and
the free-standing gel membrane comprises 10 wt % to 30 wt % polymer and 90wt % to 70 wt % liquid electrolyte.
